(19) United States
(12) Patent Application Publication
(10) Pub. No.: US 2024/0382945 A1
(43) Pub. Date: Nov. 21, 2024

(54) FUNCTIONALIZED POLYBENZIMIDAZOLE POLYMERS FOR IONOMER AND PROTON EXCHANGE MEMBRANE APPLICATIONS

(71) Applicant: 1s1 Energy, Inc., Portola Valley, CA (US)

(72) Inventors: Sukanta Bhattacharyya, Belmont, CA (US); Daniel Sobek, Portola Valley, CA (US)

(21) Appl. No.: 18/783,843

(22) Filed: Jul. 25, 2024

Related U.S. Application Data
(63) Continuation-in-part of application No. PCT/US2023/011508, filed on Jan. 25, 2023.
(60) Provisional application No. 63/302,755, filed on Jan. 25, 2022.

(51) Int. Cl. B01J 39/19; C08G 73/18; H01M 8/1004; H01M 8/103

(52) U.S. Cl. CPC B01J 39/19; C08G 73/18; H01M 8/1004; H01M 8/103; H01M 2300/0082

(57) ABSTRACT

An ion exchange-functionalized polymer molecule includes a repeating unit having a benzimidazole unit as at least part of a main chain, a side chain, or both. The ion exchange-functionalized polymer molecule also includes an ion exchange group linked to the repeating unit. The ion exchange group may be a tetravalent boron group or a metal fluoride, and the metal fluoride may be a multivalent metal atom.

### RELATED APPLICATIONS

The present application is a continuation-in-part of International Application No. PCT/US2023/011508, filed Jan. 25, 2023, which claims priority to U.S. Provisional Patent Application No. 63/302,755, filed Jan. 25, 2022, each of which is hereby incorporated by reference in its entirety.

### BACKGROUND INFORMATION

In electrochemical cells, such as hydrogen fuel cells and water electrolysis systems, proton exchange membranes (PEMs) are used to selectively transport protons. Proton exchange membranes (PEMs) are semipermeable membranes that transport protons (H⁺) while being impermeable to gases. PEMs are generally composed of a porous framework with highly acidic functional groups. For example, polyfluorosulfonic acid-based PEMs contain a poly(tetrafluoroethylene) (PTFE) porous framework with sulfonic acid groups. The easily dissociable sulfonic acid groups serve as proton transport agents in the membrane. In hydrogen fuel cells, hydrogen gas (H₂) separates at the anode into protons (H⁺) and electrons. The protons pass through a PEM and combine with oxygen gas (O₂) at a cathode to produce water while the electrons flow through an external circuit to produce electricity. In water electrolysis systems, electricity splits water at the anode into oxygen gas (O₂) and protons (H⁺). The protons pass through the PEM and combine with electrons at the cathode to produce hydrogen gas (H₂).

A membrane electrode assembly (MEA) may include a PEM positioned between a first catalyst layer and a second catalyst layer. The catalyst layers are electrically conductive electrodes (anode and cathode) with embedded electrochemical catalysts such as metals, metal alloys, or metal oxides. The catalysts may be bound to a catalyst solid support, which generally are an electrically conductive, high surface-area carbon (e.g., graphite or graphene). The electrochemical catalysts reduce the activation energy needed to carry out the electrochemical reactions at the electrodes, such as the oxygen evolution reaction (OER) and the hydrogen evolution reaction (HER) in water electrolysis applications and the hydrogen oxidation reaction (HOR) and the oxygen reduction reaction (ORR) in fuel cell applications.

In some applications, the catalyst layer includes a supported catalyst mixed with an ionomer, an ion-conducting polymer. The ionomer binds the catalysts within the electrode, binds the catalyst layer on the PEM, and provides a pathway for cations (e.g., protons), thereby improving cation conductivity. In some MEAs, the catalyst layers are formed separately from the PEM and layered on the PEM in the MEA stack. In other MEAs, the catalyst layers are coated on the PEM to form catalyst-coated membranes (CCMs).

PEMs and ionomers and the molecular functional groups therein responsible for proton transport properties should remain robust under the harsh reaction conditions of redox stress. Conventional polymers used in PEMs and as ionomers in water electrolysis and fuel cell applications mostly contain sulfonic acid functional groups as proton transport agents. The easily dissociable sulfonic acid groups serve as proton transport agents in the PEM. However, the water electrolysis and fuel cell applications involve strong oxidation and reduction chemistries under ambient to high temperature and acidic conditions. Sulfonic acid functional groups have only limited ability to withstand the redox stress from electrochemical operations, mainly due to the intrinsic physicochemical properties of sulfur.

### SUMMARY

The following description presents a simplified summary of one or more aspects of the apparatuses, compositions, and/or methods described herein in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects of the apparatuses, compositions, and/or methods described herein in a simplified form as a prelude to the more detailed description that is presented below.

In some illustrative examples, an ion exchange-functionalized polymer molecule comprises: a repeating unit comprising a benzimidazole group as at least part of a main chain, a side chain, or both; and an ion exchange group linked to the repeating unit, wherein the ion exchange group comprises a tetravalent boron group or a metal fluoride, the metal fluoride comprising a multivalent metal atom.

In some illustrative examples, a method of making an ion exchange-functionalized polymer molecule comprises linking an ion exchange agent with a repeating unit of a polymer molecule, wherein the polymer molecule comprises a benzimidazole unit as at least part of a main chain or a side chain of the polymer molecule and the ion exchange agent comprises a trivalent boron compound or a metal fluoride, the metal fluoride comprising a multivalent metal atom.

In some illustrative examples, a polybenzimidazole (PBI) polymer comprises: a main chain comprising benzimidazole units; and ion exchange groups linked to the benzimidazole units; wherein the ion exchange groups comprise tetravalent boron groups or metal fluoride groups, each metal fluoride group comprising a multivalent metal atom.

In some illustrative examples, a polymer composition comprises a first polymer crosslinked with a second polymer by a tetravalent boron crosslink, the first polymer comprising a first polybenzimidazole (PBI) polymer.

In some illustrative examples, a method of crosslinking a first polymer and a second polymer with a tetravalent boron crosslink comprises: reacting the first polymer, the second polymer, and a crosslinking agent, wherein the first polymer comprises a first polybenzimidazole (PBI) polymer comprising benzimidazole units as at least part of a main chain; and the crosslinking agent comprises boric acid, a boronic acid, or a derivative of a boronic acid.

### BRIEF DESCRIPTION OF THE DRAWINGS

In order that the concepts described herein may be better understood, various embodiments will be described by way of example only, with reference to the drawings. The drawings illustrate various embodiments and are a part of the specification. The illustrated embodiments are merely examples and do not limit the scope of the disclosure. Throughout the drawings, identical or similar reference numbers designate identical or similar elements.

FIGS. 1-4B show various illustrative reaction schemes for the synthesis of ion exchange-functionalized PBI polymer molecules.

FIG. 5 shows an illustrative reaction scheme for crosslinking two PBI polymer molecules using boric acid as a crosslinking agent.

FIG. 6 shows an illustrative reaction scheme for crosslinking a PBI polymer molecule with a hydroxyl-functionalized PTFE polymer using boric acid as a crosslinking agent.

FIG. 7 shows an illustrative reaction scheme for crosslinking a PBI polymer molecule with a hydroxyl-functionalized PTFE polymer molecule using an aminoboronic acid as a crosslinking agent.

FIG. 8 shows an illustrative reaction scheme for crosslinking a PBI polymer molecule with a PPA polymer molecule using boric acid as a crosslinking agent.

FIG. 9 shows an illustrative proton exchange membrane water electrolysis system incorporating an ion exchange-functionalized PBI polymer.

FIG. 10 shows an illustrative proton exchange membrane fuel cell incorporating an ion exchange-functionalized PBI polymer.

FIGS. 11-13 show further various illustrative reaction schemes for the synthesis of ion exchange-functionalized PBI polymer molecules.

### DETAILED DESCRIPTION

Ion exchange-functionalized polybenzimidazole (PBI) polymers, methods of making ion exchange-functionalized PBI polymers, and methods and apparatuses for using ion exchange-functionalized PBI polymers are described herein. As described herein, an ion exchange-functionalized polymer molecule includes a repeating unit and an ion exchange group. The repeating unit includes a benzimidazole unit as at least part of a main chain, a side chain, or both. An ion exchange group is linked to the repeating unit. The ion exchange group may be, for example, a tetravalent boron group or a metal fluoride group having a multivalent metal atom. In some examples, the ion exchange group is directly linked to a secondary amine of the benzimidazole unit, such as by a covalent bond between the boron atom or metal atom of the ion exchange group and a nitrogen atom of the secondary amine. In other examples, the ion exchange group is indirectly linked to the secondary amine by way of a linker. In further examples, the ion exchange group is indirectly linked to a phenyl unit of the repeating unit by way of a linker. The boron atom of the tetravalent boron group or the multivalent atom of the metal fluoride group has an expanded valence and thus is intrinsically ionic and acidic and may serve as an ion (e.g., proton) transport agent. Thus, the ion exchange-functionalized PBI polymers may be used for ionomer and PEM applications.

Also described herein is crosslinking of a PBI polymer with another polymer, such as another PBI polymer, a functionalized poly(tetrafluoroethylene) (PTFE) molecule, or a poly(phosphoric acid) (PPA) polymer, using a tetravalent boron crosslink. In the tetravalent boron crosslink, the boron atom has a negative formal charge and thus is intrinsically ionic and acidic and may serve as an ion (e.g., proton) transport agent. Thus, the crosslinked-polymers having a tetravalent boron crosslink may be used for ionomer and PEM applications.

Various definitions will now be provided to aid in understanding various aspects of the present disclosure. As used herein, each term or expression, e.g. alkyl, m, n, etc., when used more than once, is intended to be independent of its definition elsewhere in this disclosure. In case of conflict with any patent application or patent incorporated herein by reference, the present specification, including definitions, will control.

As used herein, “polymer” refers to a substance comprising polymer molecules of the same or different polymer species, including a mixture of polymer molecules of the same polymer species which may differ from other polymer molecules within the same sample in chain length and/or particular structural arrangement (e.g., irregularities in the orientation of monomer units, end-groups, and/or in the locations and/or lengths of any side chains or side groups). “Polymer” includes homopolymers, copolymers, terpolymers, interpolymers, and so on.

As used herein, “polymer molecule” or “macromolecule” refers to a molecule of high relative molecular mass, the structure of which comprises a relatively large repetition of units (e.g., about 100 or more monomer units) derived, actually or conceptually, from molecules of low relative molecular mass (e.g., monomer molecules).

As used herein, “polymerization” refers to the process of converting a monomer, or a mixture of monomers, into a polymer.

As used herein, “oligomer” refers to a substance composed of oligomer molecules.

As used herein, “oligomer molecule” refers to a molecule of intermediate relative molecular mass, the structure of which comprises a relatively small repetition of units (e.g., about 10 to about 100 monomer units) derived, actually or conceptually, from molecules of lower relative molecular mass (e.g., monomer molecules).

As used herein, “oligomerization” refers to the process of converting a monomer or a mixture of monomers into an oligomer.

As used herein, “ionomer” refers to a polymer composed of ionomer molecules.

As used herein, “ionomer molecule” refers to a polymer molecule in which a small but relatively significant proportion of the constitutional units have ionizable or ionic pendant groups (including the ion exchange groups described herein), or both. Generally, no more than approximately 15 mole percent of the constitutional units have ionizable or ionic pendant groups.

As used herein, “monomer” refers to a substance composed of monomer molecules.

As used herein, “monomer molecule” refers to a molecule that can undergo polymerization or oligomerization to form a polymer molecule or an oligomer molecule. A monomer molecule contributes constitutional units to the essential structure of a polymer molecule or an oligomer molecule.

As used herein, “copolymer” refers to a polymer derived from more than one species of monomer.

As used herein, “constitutional unit” refers to an atom or a group of atoms (with pendant atoms or groups, if any) comprising a part of the structure of a polymer molecule (or oligomer molecule, block, or chain).

As used herein, “repeating unit” refers to the constitutional unit the repetition of which constitutes a polymer molecule (or oligomer molecule, block, or chain).

As used herein, “monomer unit” refers to the largest constitutional unit contributed by a single monomer molecule to the structure of a polymer molecule or an oligomer molecule.

As used herein, “block” refers to a portion of a polymer molecule (or oligomer molecule) comprising many constitutional units and that has at least one feature which is not present in the adjacent portions.

As used herein, “chain” refers to the whole or part of a polymer molecule (or oligomer molecule or block), comprising a linear or branched sequence of constitutional units between two boundary constitutional units, each of which may be either an end-group, a branch point, or an otherwise-designated characteristic feature of the polymer molecule.

As used herein, “main chain” or “backbone” refers to the chain of a polymer molecule to which all other chains (long or short or both) may be regarded as being pendant (e.g., a side chain).

As used herein, “side chain” refers to an oligomeric (short chain) or polymeric (long chain) offshoot from the main chain of a polymer molecule.

As used herein, “side group” or “pendant group” refers to an offshoot, neither oligomeric nor polymeric, from a chain (e.g., from a main chain).

As used herein, “crosslink” refers to a small region in a polymer molecule from which at least four chains emanate. A crosslink is generally formed by reactions involving sites or groups on existing polymer molecules or by interactions between existing polymer molecules.

The term “crosslinked” refers to the state in which polymer molecules that were earlier separate polymer molecules are linked to one another at points other than their ends, usually by covalent bonds.

As used herein, “aliphatic” compounds are hydrocarbons that are saturated or unsaturated, acyclic or cyclic, unbranched or branched, unsubstituted or substituted with one or more substituents or functional groups. As will be appreciated by one of ordinary skill in the art, “aliphatic” is intended herein to include, but is not limited to, alkyl, alkenyl, and alkynyl moieties. Illustrative aliphatic groups include, but are not limited to, for example, methyl, ethyl, n-propyl, isopropyl, allyl, n-butyl, sec-butyl, isobutyl, tert-butyl, n-pentyl, sec-pentyl, isopentyl, tert-pentyl, n-hexyl, and sec-hexyl moieties.

As used herein, the term “alkyl” is given its ordinary meaning in the art and may include saturated aliphatic groups, including straight-chain alkyl groups, branched-chain alkyl groups, cycloalkyl (alicyclic) groups, alkyl substituted cycloalkyl groups, and cycloalkyl substituted alkyl groups. An analogous convention applies to other generic terms such as “alkenyl,” “alkynyl,” and the like. Furthermore, as used herein, the terms “alkyl,” “alkenyl,” “alkynyl,” and the like encompass both substituted and unsubstituted groups.

In some embodiments, a straight or branched alkyl chain may have 1 to 30 carbon atoms in its backbone, and, in some cases, 1 to 20 or fewer. In some embodiments, a straight or branched alkyl chain has 1 to 10 carbon atoms in its backbone (e.g., C1-C10 for straight chain, C3-C10 for branched chain), has 6 or fewer carbon atoms, or has 4 or fewer carbon atoms. Cycloalkyls may have from 3 to 10 carbon atoms in their ring structure or, in some case, from 3 to 5, 6 or 7 carbon atoms in the ring structure. Examples of non-cyclic alkyl groups include, but are not limited to, methyl, ethyl, propyl, isopropyl, butyl, isobutyl, n-butyl, tert-butyl, n-pentyl, neopentyl, n-hexyl, n-heptyl, n-octyl, n-decyl, n-undecyl, and dodecyl. Examples of cyclic alkyl groups include, but are not limited to, cyclopropyl cyclobutyl, and cyclochexyl.

The terms “alkenyl” and “alkynyl” refer to unsaturated aliphatic groups analogous in length and possible substitution to the alkyls described above, but that contain at least one double or triple bond respectively. Alkenyl groups include, but are not limited to, for example, ethenyl, propenyl, butenyl, 1-methyl-2-buten-1-yl, and the like. Non-limiting examples of alkynyl groups include ethynyl, 2-propynyl (propargyl), 1-propynyl, and the like.

The term “heteroalkyl” refers to an alkyl group in which one or more hydrogen atoms bonded to any carbon of the alkyl group or one or more carbon atoms are replaced by a heteroatom. A heteroatom is any atom other than carbon. In some examples, a heteroatom is an atom selected from the group consisting of N, O, P, B, S, Si, Sb, Al, Sn, As, Se and Ge. Examples of heteroalkyl groups include, without limitation, methoxy, ethoxy, propoxy, isopropoxy, methylthio, ethylthio, propylthio, isopropylthio, n-butylthio, methoxymethyl, and cyano groups.

The terms “heteroalkenyl” and “heteroalkynyl” refer to unsaturated aliphatic groups analogous in length and possible substitution to the heteroalkyls described above, but that contain at least one double or triple bond respectively.

The term “aryl” refers to aromatic carbocyclic groups, unsubstituted or substituted, having a single ring (e.g., phenyl), multiple rings (e.g., biphenyl), or multiple fused rings, in which at least one ring is aromatic (e.g., 1,2,3,4-tetrahydronaphthyl, naphthyl, anthryl, or phenanthryl). That is, at least one ring may have a conjugated Pi electron system, while other, adjoining rings can be cycloalkyls, cycloalkenyls, cycloalkynyls, aryls, and/or heterocycyls. “Carbocyclic aryl groups” refer to aryl groups wherein the ring atoms on the aromatic ring are carbon atoms. Carbocyclic aryl groups include monocyclic carbocyclic aryl groups and polycyclic or fused compounds (e.g., two or more adjacent ring atoms are common to two adjoining rings) such as naphthyl group. Examples of aryl groups include, without limitation, phenyl, naphthyl, tetrahydronaphthyl, indanyl, and indenyl.

The term “heteroaryl” refers to aryl groups comprising at least one heteroatom as a ring atom, such as a heterocycle. Non-limiting examples of heteroaryl groups include, without limitation, pyridyl, pyrazinyl, pyrimidinyl, pyrrolyl, pyrazolyl, imidazolyl, thiazolyl, oxazolyl, isooxazolyl, thiadiazolyl, oxadiazolyl, thiophenyl, furanyl, quinolinyl, and isoquinolinyl.

The terms “alkoxyl” or “alkoxy” as used herein refers to an alkyl group having an oxygen radical attached thereto, and has the general formula R—O. Examples of alkoxyl groups include, without limitation, methoxy, ethoxy, propyloxy, and tert-butoxy groups.

The term “aryloxy” refers to an aryl group having an oxygen radical attached thereto. An examples of an alkoxyl group includes, without limitation, a phenoxy group.

Any of the above groups may be optionally substituted. Examples of substituents include, without limitation, aliphatic, alicyclic, heteroaliphatic, heteroalicyclic, halogen, azide, alkyl, aralkyl, alkenyl, alkynyl, cycloalkyl, hydroxyl, alkoxyl, amino, nitro, sulfhydryl, imino, amido, phosphonate, phosphinate, carbonyl, carboxyl, alkyloxycarbonyl, silyl, ether, alkylthio, heteroalkylthio, heteroarylthio, sulfonyl, sulfonamido, ketone, aldehyde, ester, heterocyclyl, aromatic or heteroaromatic moieties, —CF₃, —CN, aryl, aryloxy, perhaloalkoxy, aralkoxy, heteroaryl, heteroaryloxy, heteroarylalkyl, heteroaralkoxy, azido, amino, halide, alkylthio, oxo, acylalkyl, carboxy esters, -carboxamido, acyloxy, aminoalkyl, alkylaminoaryl, alkylaryl, alkylaminoalkyl, alkoxyaryl, arylamino, aralkylamino, alkylsulfonyl, -carboxamidoalkylaryl, -carboxamidoaryl, hydroxyalkyl, haloalkyl, alkylaminoalkylcarboxy-, aminocarboxamidoalkyl-, cyano, alkoxyalkyl, perhaloalkyl, arylalkyloxyalkyl, (e.g., SO4(R′)₂), a phosphate (e.g., PO4(R′)₃), a silane (e.g., Si(R′)₄), a urethane (e.g., R′O(CO)NH_{R}′), and the like. Additionally, the substituents may be selected from F, Cl, Br, I, —OH, —NO₂, —CN, —NCO, —CF₃, —CH₂CF₃, —CHCl₂, —CH₂ORx, —CH₂CH₂ORx, —CH₂N(Rx)₂, —CH₂SO₂CH₃, —C(O)Rx, —O₂(Rx), —CON(Rx)₂, —OC(O)Rx, —C(O)OC(O)Rx, —OCO₂Rx, —OCON(Rx)₂, —N(Rx)₂, —S(O)₂Rx, —OCO₂Rx, —NRx(CO)Rx, —NRₓ(CO)N(Rₓ)₂, wherein each occurrence of Rₓ independently includes, but is not limited to, hydrogen, aliphatic, alicyclic, heteroaliphatic, heteroalicyclic, aryl, heteroaryl, alkylaryl, or alkylheteroaryl, wherein any of the aliphatic, alicyclic, heteroaliphatic, heteroalicyclic, alkylaryl, or alkylheteroaryl substituents described above and herein may be substituted or unsubstituted, branched or unbranched, cyclic or acyclic, and wherein any of the aryl or heteroaryl substituents described above and herein may be substituted or unsubstituted.

Polybenzimidazole (PBI) polymers are a class of polymers composed of PBI polymer molecules. PBI polymer molecules have a repeating unit that includes a benzimidazole unit as at least part of a main chain. The benzimidazole unit comprises a benzimidazole moiety or a derivative thereof. Benzimidazole is a heterocyclic aromatic organic compound having a phenyl group and an imidazole group that share two carbon atoms in their ring structures. The general structure of benzimidazole is shown in the following Formula (I):

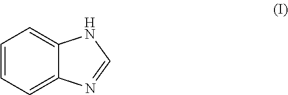

An example of a PBI polymer with one benzimidazole unit per repeating unit in a main chain is poly(2,5-benzimidazole) (AB-PBI), shown below as Formula (II), and examples of PBI polymers with two benzimidazole units per repeating unit in a main chain are poly [2,2′-(m-phenylene)-5,5′-bibenzimidazole] (m-PBI), shown below as Formula (III), and 4F-PBI (a fluorinated derivative of m-PBI), shown below as Formula (IV).

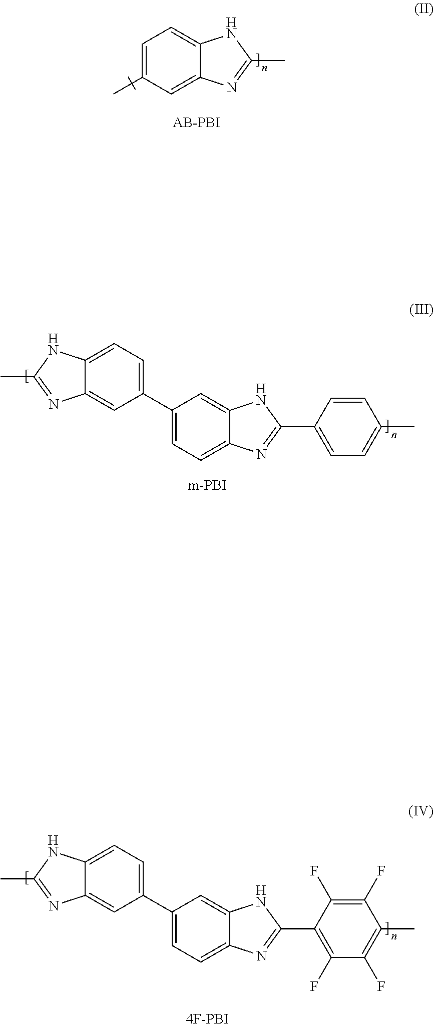

Other examples of PBI polymers include, without limitation, poly {2,6-(2,6-naphtyliden)-1,7-dihydrobenzo[1,2-d;4,5-d′]diimidazole}; poly 2,2′-(2,6-naphtyliden)-5,5′-bibenzimidazole; poly-2,2′-(2,6-pyridine)-5,5′-bibenzimidazole; poly-2,2′-(2,5-pyridine) 5,5′-bibenzimidazole; poly-2,2′-(2,2′-bipyridine-5,5′)-5,5′-bibenzimidazole); poly-2,2′-(3,5-pyrazole)-5,5′-bibenzimidazole; poly-2,2′-(m-phenylene)-5,5′-bibenzimidazole; poly-2,2′-(pyridylene-3″, 5″)-5,5′-bibenzimidazole; poly-2,2′-(furylene-2″,5″)-5,5′-bibenzimidazole; poly-2.2-(naphthalene-1″,6″)-5,5′-bibenzimidazole; poly-2,2′-(biphenylene-4″,4″)-5,5′-bibenzimidazole; poly-2,2′-amylene-5,5′-bibenzimidazole; poly-2,2′-octamethylene-5,5′-bibenzimidazole; poly-2,6-(m-phenylene)-diimidazolebenzene; poly-2,2′-cyclohexenyl-5,5′-bibenzimidazole; poly-2,2′-(m-phenylene)-5.5′di(benzimidazole)ether; poly-2,2′-(m-phenylene)-5,5-di(benzimidazole)sulfide; poly-2,2′-(m-phenylene)-5,5-di(benzimidazole)sulfone; poly-2,2′-(m-phenylene)-5,5-di(benzimidazole)methane; poly-2-2″-(m-phenylene)-5″.5″-(di(benzimidazole)propane 2.2; poly-2.2″-(m-phenylene)-5′5″-di(benzimidazole)ethylene-1,2; and derivatives of any of the foregoing (e.g., substituted (fluorinated) and/or branched derivatives).

In some examples, a PBI polymer is a copolymer that comprises one or more additional repeating units, which may or may not include a benzimidazole unit in a main chain, in a side chain, or both.

In a PBI polymer molecule, a secondary amine group of a benzimidazole unit (e.g., the N of the C—NH—C group) is available for linking, either directly or indirectly, with an ion exchange agent to thereby form an ion exchange-functionalized PBI polymer molecule in which the PBI polymer molecule is functionalized with an ion exchange group. In a direct link, a boron atom or metal atom of the ion exchange group is covalently bonded to the nitrogen atom of the secondary amine group. In some examples of an indirect link, the ion exchange group is linked to the secondary amine by way of a linker (e.g., an alkyl chain, a sulfonic ester linker, and/or a sulfuryl linker). In other examples of an indirect link, the ion exchange group is linked to the phenyl group of the benzimidazole unit by way of a sulfonic acid linker.

Illustrative ion exchange-functionalized PBI polymer molecules and oligomer molecules, and methods of making ion exchange-functionalized PBI polymer molecules and oligomer molecules, will now be described. In the description that follows, discussion of and reference to polymer molecules applies equally to oligomer molecules, and discussion of and reference to polymer molecules can be extended to polymers (and oligomers) composed of the polymer molecules described herein.

Ion exchange-functionalized PBI polymers and polymer molecules will now be described. However, the principles and concepts described herein are not limited to PBI polymers and polymer molecules but may be applied to any polymers and polymer molecules that have a benzimidazole unit, an imidazole unit, or a phenyl unit (in the case of indirect linking) as at least part of a main chain, a side chain, or both.

In some aspects, an ion exchange-functionalized PBI polymer molecule (or oligomer molecule) comprises: (i) a repeating unit that includes a benzimidazole unit, and, optionally, a phenyl unit; and (ii) at least one ion exchange group linked to a secondary amine of a benzimidazole unit and/or to a phenyl unit.

The repeating unit of the ion exchange-functionalized PBI polymer molecule includes a benzimidazole unit as at least part of a main chain, as at least part of a side chain, or both. The benzimidazole unit comprises a benzimidazole moiety or a derivative thereof, as explained above with reference to Formula (I). The repeating unit may include any additional moieties and/or groups as may serve a particular implementation. In some aspects, the repeating unit comprises the repeating unit of a PBI polymer molecule described above, or a derivative thereof. In some examples, such as in m-PBI (see Formula (III)) and derivatives thereof, the repeating unit also includes a separate phenyl group as at least part of the main chain, as at least part of a side chain, or both.

The at least one ion exchange group comprises a tetravalent boron group or a metal fluoride group comprising a multivalent metal atom. As used herein, “multivalent” means that an atom is not restricted to a specific number of valence bonds, but may have multiple different valence states each with a different number of valence bonds. Thus, a trivalent atom that is multivalent may “expand its valence state,” such as by one to three to form a tetravalent, pentavalent, or hexavalent structure with a negative one (−1), negative two (−2), or negative three (−3) formal charge. For example, boron has three valence electrons and has a ground state electron configuration of 1s²2s²2p¹. Boron generally forms trivalent neutral compounds in which boron has three covalent bonds. Thus, the boron atom is sp² hybridized with an empty p-orbital, which makes trivalent boron compounds electron-deficient. However, boron is multivalent due to the empty p-orbital, thus enabling boron to form negatively charged tetravalent compounds with four covalent bonds. Similarly, multivalent metal atoms may expand their valence to form one or more additional covalent bonds and thereby gain a formal negative charge, which may be balanced by an appropriate number of cations.

A tetravalent boron group has the general formula —BX₃ wherein each X is independently an alkyl group, an alkoxy group, an alkyloxycarbonyl group, an aryl group, an aryloxy group, a hydroxyl group, a fluoro group, a cyano group, or a pentafluorophenyl group. In embodiments in which each X is a fluoro group, the tetravalent boron group is a boron trifluoride group having the general formula —BF₃.

The boron atom of the tetravalent boron group is covalently bonded to each X of the tetravalent boron group and to the secondary amine group of the benzimidazole unit or to a linker that links the tetravalent boron group to the secondary amine group. Thus, the boron atom has four covalent bonds, making the boron atom intrinsically ionic. As a result, the tetravalent boron group may serve as an ion exchange group (e.g., a proton transport agent).

The metal fluoride group has the general formula —MF₃ or —MF₄ where M is a multivalent metal atom. As used herein, a “metal atom” may be a transition metal atom, a metal atom, or a metalloid atom. In some examples, M comprises a Group 4 metal atom (e.g., zirconium (Zr)), a Group 13 metal atom (e.g., aluminum (Al), gallium (Ga), or indium (In)), or a Group 14 metal atom (e.g., silicon (Si), germanium (Ge), or tin (Sn)).

As mentioned, in some examples the boron atom of the tetravalent boron group or the metal atom of the metal fluoride group is linked to the secondary amine group by way of a linker, such as an alkyl linker, a sulfonic ester linker, and/or a sulfuryl linker. In some examples, the linker is an alkyl group having 1 to 10 atoms and optionally may be substituted with one or more side groups or side chains, each of which may independently be hydrogen, a hydroxyl group, a fluoro group, a chloro group, a dialkylamino group (NR₂, in which R may represent hydrogen or an organic combining group, such as a methyl group (CH₃)), a cyano group, a carboxylic acid group, a carboxylic amide group, an ester group, an alkyl group, an alkoxy group, or an aryl group. In other examples, the linker is or includes a sulfonic ester linker and/or a sulfuryl linker. For example, the benzimidazole unit may be activated by sulfonation with a pendant sulfonic acid group, which may combine with an ion exchange agent, resulting in an ion exchange group linked to the benzimidazole unit by a sulfonic ester linker.

In further examples, the boron atom of the tetravalent boron group or the metal atom of the metal fluoride group is indirectly linked to a phenyl group of the repeating unit by way of a linker, such as a sulfonic ester linker (e.g., a derivative of sulfonic acid). As will be explained below, the phenyl group may be activated by sulfonation with a pendant sulfonic acid group, which may combine with an ion exchange agent to form the ion exchange group.

An ion exchange-functionalized PBI polymer molecule may be synthesized in any suitable way. In some examples, an ion exchange-functionalized PBI polymer molecule is synthesized by a post-polymerization process (e.g., after synthesis of a PBI polymer molecule).

In some examples, a post-polymerization process may be carried out with a single step in which an ion exchange agent is reacted with a PBI polymer molecule. The ion exchange agent comprises a trivalent boron compound or a metal fluoride and, when linked with the PBI polymer molecule, forms the ion exchange group.

The trivalent boron compound has the general formula BX₃ where X is as described above. In the reaction, the boron atom of the trivalent boron compound expands its valence and covalently bonds with the nitrogen atom of the secondary amine of the benzimidazole unit, thus forming an ion exchange group in which the boron atom is directly linked with the secondary amine of the benzimidazole unit.

The metal fluoride has the general formula MF₃ or MF₄ where M comprises a multivalent metal atom, as described above. In the reaction, the multivalent metal atom of the metal fluoride expands its valence and covalently bonds with the nitrogen atom of the secondary amine of the benzimidazole unit, thus forming an ion exchange group in which the metal atom is directly linked with the secondary amine of the benzimidazole unit.

In other examples, a post-polymerization process for indirect linking with the secondary amine may be carried out in a multi-step process. For example, in a first step, a linking agent is reacted with a PBI polymer molecule. The linking agent bonds with the secondary amine of a benzimidazole unit and, when linked with the PBI polymer molecule, forms an intermediate linker (e.g., an alkyl chain having a chain length ranging from 2 to 10 carbon atoms or a sulfonic acid group) presenting a pendant acid group or hydroxyl group.

In some examples, the linking agent comprises a sulfonated compound. Sulfonated compounds are esters of sulfonic acid and have the general formula —S(═O)₂OR in which R is an electron pair, hydrogen, an alkyl group, or an aryl group. Sulfonated compounds link, by way of the sulfur atom, with the secondary amine of benzimidazoles to form an intermediate linker with a terminal sulfonic acid group (or sulfamic acid group). Illustrative examples of sulfonated compounds include, without limitation, mesylate (methanesulfonate), triflate (trifluoromethanesulfonate), ethanesulfonate (esilate, esylate), tosylate (p-toluenesulfonate), benzensulfonate (besylate), closilate (closylate, chlorobenzenesulfonate), camphorsulfonate (camsilate, camsylate), pipsylate (p-iodobenzenesulfonate derivative), and sulfonic acids (e.g., chlorosulfonic acid, bromosulfonic acid, iodosulfonic acid, etc.).

In some examples, the sulfonated linking agent comprises a sultone. Sultones are cyclic sulfonate esters, many of which are 4- to 6-membered rings (having 2 to 4 carbon atoms), although some sultones are 7-membered rings or larger (having 5 or more carbon atoms). Sultones are reactive with primary and secondary amines, including the secondary amine of benzimidazole. Illustrative examples of sultones include, without limitation, beta-sultone, 1,3-propane sultone; 1,4-butane sultone; prop-1-ene-1,3-sultone; 3,4,4-trifluoro-3-(trifluoromethyl)oxathietane 2,2-dioxide; 3,3,4,4-tetrafluoro-1,2-oxathietane 2,2-dioxide; naphth[1,8-cd]-1,2-oxathiole, 2,2-dioxide; 5-methyl-1,2-oxathiolane 2,2-dioxide; 3-methyl-1,2-oxathiolane 2,2-dioxide; 1,////2-oxathiane, 6-dodecyl-, 2,2-dioxide; 4,6-dimethyl-1,2-oxathiine 2,2-dioxide; acetyl fluoride, difluoro(fluorosulfonyl). Reaction of sultones with the secondary amine of idazole units opens up an alkyl linker chain with a terminal sulfonic acid group.

In other examples, the linking agent comprises an alkyl linking agent that reacts with secondary amines and forms a linker with a pendant acid group (e.g., a terminal carboxylic acid group, a phosphoric acid group, a phosphonic acid group, a sulfonic acid group, a sulfuric acid group, etc.), or a hydroxyl group (e.g., an alcohol linker). In some examples, the alkyl linking agent has a 2- to 10-carbon chain length. Illustrative alkyl linking agents include, without limitation, halogenated acids, alcohols, aldehydes, and ketones with a pendant or terminal acid group. In some examples, the alkyl linking agent comprises a halogenated carboxylic acid where the halogen is selected from the group consisting of chlorine, bromine, and iodine. Examples of halogenated carboxylic acids include, without limitation, bromoacetic acid and chloroacetic acid. The linking agent may be unsubstituted or wholly or partially substituted, as described above for the linker. In some examples, the linking agent is substituted with fluorine (e.g., tetrafluoro β-sultone).

In a second step, an ion exchange agent is reacted with the pendant acid group or pendant hydroxyl group of the intermediate linker. The ion exchange agent readily reacts with the pendant acid group or pendant hydroxyl group. The ion exchange agent is as described above and, when linked with the PBI polymer molecule by way of the linker chain, forms the ion exchange group.

In some examples, the alkyl linking agent comprises a halogenated alkylsulfonyl fluoride, such as chloroalkylsulfonyl fluoride or bromoalkylsulfonyl fluoride, which forms a first intermediate sulfonyl fluoride-terminated alkyl linker. Prior to performing the second step, the sulfonyl fluoride-terminated alkyl linker is activated to sulfonic acid (by any suitable method), after which the second step is performed to react the ion exchange agent with the sulfonic acid group.

In other examples of indirect linking, an intermediate linker having a pendant acid group is formed in two steps, and the acid group is converted to an ion exchange group in a third step. In the first step, a sulfuryl linking agent reacts, by way of the sulfur atom, with the secondary amine of the benzimidazole unit to form a first intermediate linker (a sulfuryl linker) having a pendant leaving group. A sulfuryl linking agent is a sulfuryl compound having a sulfuryl group (—S(═O)2—) and two leaving groups (e.g., halides). Illustrative examples of sulfuryl compounds include, without limitation, sulfuryl fluoride (FS(O₂)F), sulfuryl chloride (ClS(O₂)Cl), sulfuryl bromide (BrS(O₂)Br), and sulfuryl iodide (IS(O₂)I).

In the second step, a second linking agent having a pendant or terminal amino group and a pendant or terminal sulfonic acid group reacts, by the sulfur atom of the amino group, with the first intermediate linker (sulfuryl linker) by a sulfur-nitrogen (S—N) bond. The second linking agent may be any aminoaryl sulfonic acid compound or derivative thereof, such as, but not limited to, aminobenzene sulfonic acid (sulfanilic acid) and compounds having multiple sulfonic acid groups in the aryl ring(s). The reaction results in a second intermediate linker having a pendant sulfonic acid group.

In the third step, the sulfonic acid group is converted into a tetravalent boron group using BF₃ (in the form of BF₃ etherate (Et₂O)), as described above, thus producing an ion exchange-functionalized polymer molecule having a tetravalent boron group linked to a benzimidazole unit by way of a sulfonic ester linker and a sulfuryl linker. The boron atom of the tetravalent boron group has a negative formal charge and thus the ion exchange group is intrinsically ionic, thereby enabling ion (e.g., proton or other cation) exchange.

In an alternative example of indirect linking using a sulfuryl linking agent, in the second step an ion exchange group reacts directly with the first intermediate linker (the sulfuryl linker). In this example, the ion exchange agent includes a metal salt of an aminoaryl or aminoalkyl tetravalent boron salt. The ion exchange agent includes at least one tetravalent boron group as described above (e.g., trifluoroborate), which has a negative formal charge and thus is intrinsically ionic. An aryl ring in the ion exchange group may include any suitable number of tetravalent boron groups. The metal countercation of the tetravalent boron group may be, for example, lithium (Li⁺), sodium (Na⁺), potassium (K⁺), or cesium (Cs⁺). Illustrative examples of the ion exchange agent include potassium aminotrifluoroborates, including, without limitation, potassium 1,4-aminoaryltrifluoroborate and amine derivatives of potassium 4-acetylphenyltrifluoroborate, potassium 4-tert-butylphenyltrifluoroborate, potassium 4-chlorophenyltrifluoroborate, potassium 2,4-difluorophenyltrifluoroborate, potassium 4-methoxyphenyltrifluoroborate, potassium 5-methyl-2-thiophenetrifluoroborate, and potassium vinyltrifluoroborate, wherein the alkyl and/or aryl groups may be substituted or unsubstituted. In the second step, the amino group of the ion exchange group reacts with the first intermediate linker (the sulfuryl linker) by a sulfur-nitrogen (S—N) bond to form an ion exchange group (the tetravalent boron group) linked with the benzimidazole unit by way of a sulfuryl linker. Optionally, the metal cation may then be replaced by a proton in an acidification step.

In other examples, a post-polymerization process for indirect linking of an ion exchange group with a phenyl group of a PBI polymer (e.g., m-PBI) may be carried out in a multi-step process. In a first step, the PBI polymer is sulfonated (e.g., activated with sulfonic acid) at the phenyl unit to introduce an intermediate pendant sulfonic acid group. The PBI polymer may be sulfonated in any suitable way. In some examples, the PBI polymer is sulfonated through direct sulfonation by combining the PBI polymer with a sulfonating agent, such as sulfur trioxide (SO₃) and/or sulfuric acid (H₂SO₄).

In a second step, an ion exchange agent is reacted with the pendant sulfonic acid group, as described above. The ion exchange agent readily reacts with the pendant sulfonic acid group. The ion exchange agent is as described above and, when linked with the PBI polymer molecule by way of the pendant sulfonic acid group, forms the ion exchange group.

The degree of functionalizing a PBI polymer molecule with an ion exchange group may be controlled as desired. In some examples, the PBI polymer molecule comprises an ionomer molecule in which approximately 15 mole percent of the repeating units (or of the benzimidazole units or phenyl units) are functionalized with an ion exchange group. In further examples, approximately 10 mole percent of the repeating units (or of the benzimidazole units or phenyl units) are functionalized with an ion exchange group. In yet further examples, approximately 5 mole percent of the repeating units (or of the benzimidazole units or phenyl units) are functionalized with an ion exchange group. In other examples, more than 15 mole percent of the repeating units (or of the benzimidazole units or phenyl units) are functionalized with an ion exchange group, such as 20 mole percent or more, 30 mole percent or more, 50 mole percent or more, or 75 mole percent or more.

In the examples described above, ion exchange-functionalized PBI polymers are formed by the post-polymerization functional modification of a PBI polymer. In other examples, ion exchange-functionalized PBI polymers may be formed by the pre-polymerization functional modification of monomer molecules comprising a benzimidazole moiety and, optionally, a phenyl moiety.

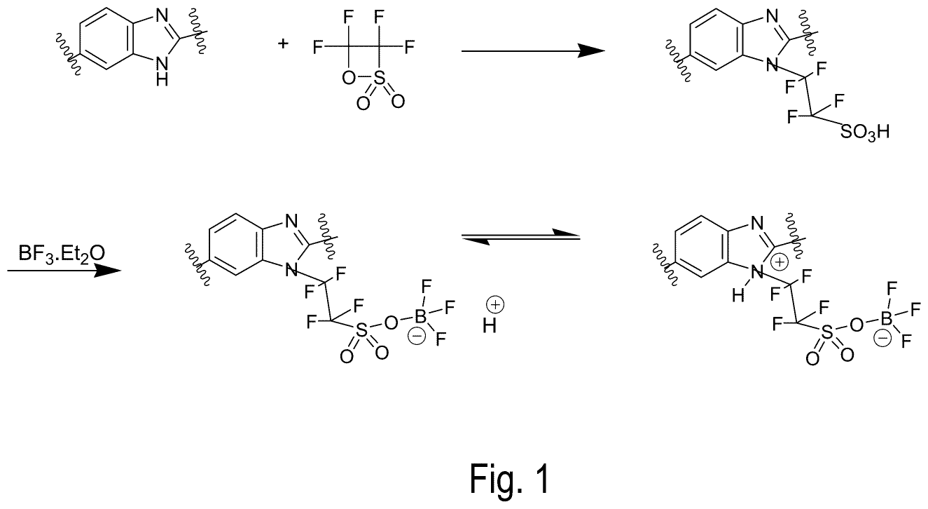

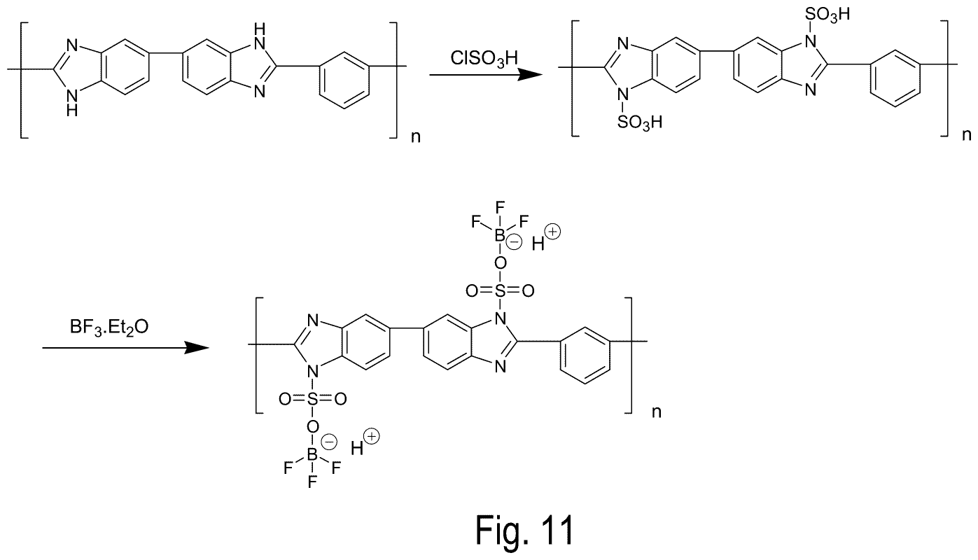

Illustrative examples of ion exchange-functionalized PBI polymers, and reaction schemes for synthesizing ion exchange-functionalized PBI polymers, will now be shown and described with reference to FIGS. 1-4B and 11-13. The following examples are merely illustrative and are not limiting. In FIGS. 1-4B, only a benzimidazole unit of the repeating unit of the PBI polymer molecules is shown, but the repeating unit may have any other units and structure as may serve a particular implementation. In FIGS. 11-13, a particular PBI polymer molecule is shown, but the reaction schemes may be performed with any other polymer molecules including a benzimidazole unit, including any other PBI polymer molecules.

FIG. 1 shows an illustrative reaction scheme for the synthesis of an ion exchange-functionalized PBI polymer molecule. In a first step, a tetrafluoro β-sultone linking agent reacts with the secondary amine of the benzimidazole unit to form an intermediate linker chain. The intermediate linker chain is a perfluorinated 2-carbon chain with a terminal sulfonic acid group. In a second step, the sulfonic acid group is converted into a tetravalent boron group using BF₃ (in the form of BF₃ etherate (Et₂O)), thus producing an ion exchange-functionalized PBI polymer molecule. The boron atom of the tetravalent boron group has a negative formal charge and thus the ion exchange group is intrinsically ionic, thereby enabling ion (e.g., proton) exchange. While FIG. 1 shows the use of a perfluorinated sultone, in alternative examples the sultone is not fluorinated.

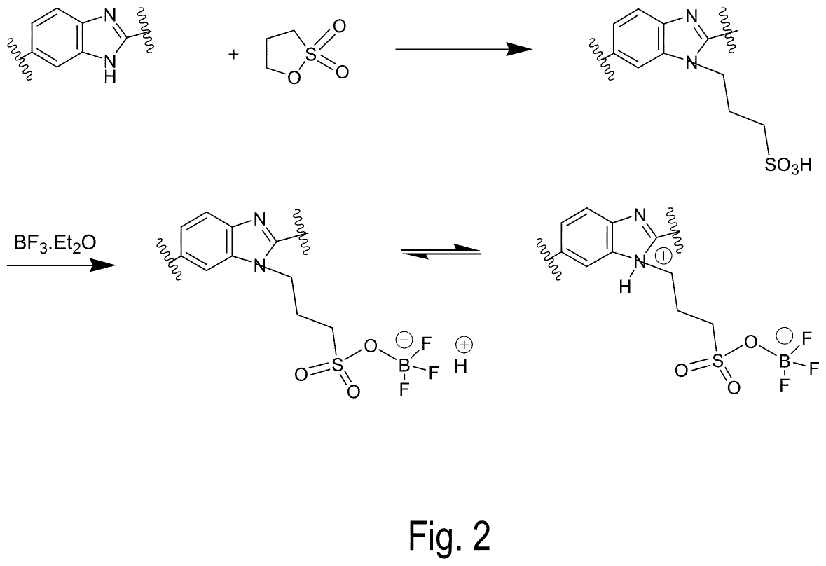

FIG. 2 shows another illustrative reaction scheme for the synthesis of an ion exchange-functionalized PBI polymer molecule. FIG. 2 is similar to FIG. 1 except that, in FIG. 2, the linking agent is 1,3-propane sultone. In a first step, the 1,3-propane sultone linking agent reacts with the secondary amine of the benzimidazole unit to form an intermediate linker chain. The intermediate linker chain is a 3-carbon chain with a terminal sulfonic acid group. In a second step, the sulfonic acid group is converted into a tetravalent boron group using BF₃ (in the form of BF₃ etherate). The boron atom of the tetravalent boron group has a negative formal charge and thus the ion exchange group is intrinsically ionic, thereby enabling ion (e.g., proton) exchange. While FIG. 2 shows the use of an unsubstituted sultone, in alternative examples the sultone may be substituted, such as with one or more fluorine atoms.

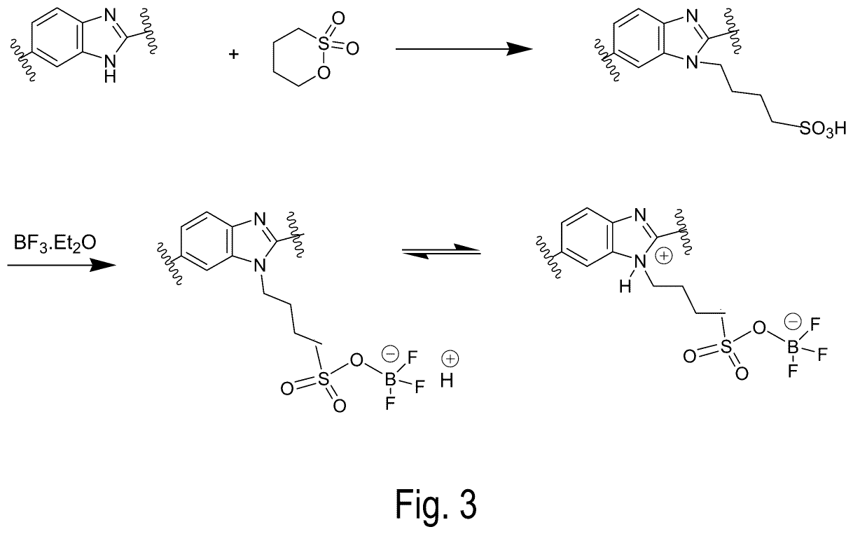

FIG. 3 shows another illustrative reaction scheme for the synthesis of an ion exchange-functionalized PBI polymer molecule. FIG. 3 is similar to FIG. 1 except that, in FIG. 3, the linking agent is 1,4-butane sultone. In a first step, the 1,4-butane sultone linking agent reacts with the secondary amine of the benzimidazole unit to form an intermediate linker chain. The intermediate linker chain is a 4-carbon chain with a terminal sulfonic acid group. In a second step, the sulfonic acid group is converted into a tetravalent boron group using BF₃ etherate. The boron atom of the tetravalent boron group has a negative formal charge and thus the ion exchange group is intrinsically ionic, thereby enabling ion (e.g., proton) exchange. While FIG. 3 shows the use of an unsubstituted sultone, in alternative examples the sultone may be substituted, such as with one or more fluorine atoms.

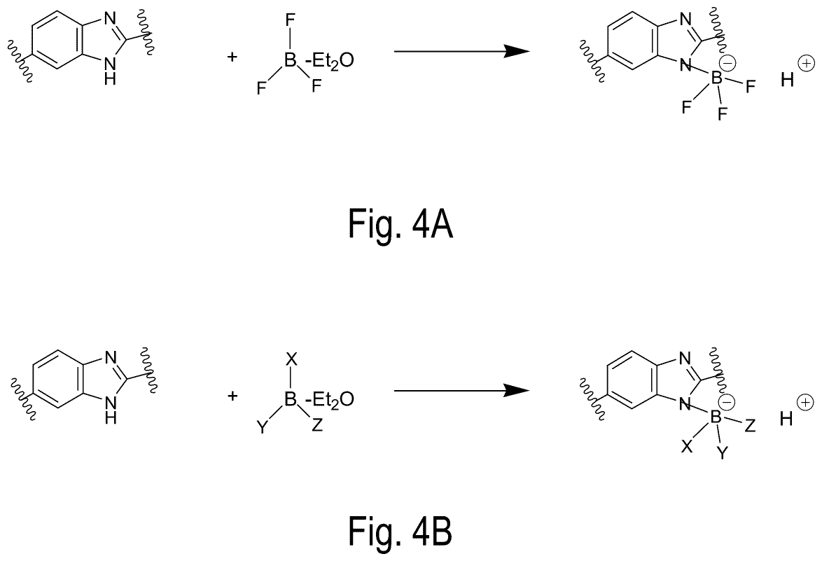

FIG. 4A shows another illustrative reaction scheme for the synthesis of an ion exchange-functionalized PBI polymer molecule. FIG. 4 is similar to FIG. 1 except that, in FIG. 4, the linking agent is boron trifluoride (in the form of BF₃ etherate) and boron trifluoride reacts directly with the secondary amine of the benzimidazole unit to form an ion exchange group (a tetravalent boron group having the general formula —BF₃). The boron atom of the ion exchange group has a negative formal charge, and thus the ion exchange group is intrinsically ionic and acidic, thereby enabling ion (e.g., proton) exchange.

FIG. 4B shows another illustrative reaction scheme for the synthesis of an ion exchange-functionalized PBI polymer molecule. FIG. 4B is similar to FIG. 4A except that, in FIG. 4B, the ion exchange group is a trivalent boron compound having the general formula BXYZ in which X, Y, and Z are the same or different and each independently represents an alkyl group, an alkoxy group, an alkyloxycarbonyl group, an aryl group, an aryloxy group, a hydroxyl group, a fluoro group, a cyano group, or a pentafluorophenyl group. The trivalent boron trifluoride reacts directly with the secondary amine of the benzimidazole group to form an ion exchange group (a tetravalent boron group having the general formula —BXYZ). The boron atom of the ion exchange group has a negative formal charge, and thus the ion exchange group is intrinsically ionic and acidic, thereby enabling ion (e.g., proton) exchange. The acidic properties of the tetravalent boron group may be tuned up by partial or full displacement of X, Y and Z groups with highly electronegative fluorine atoms.

FIG. 11 shows another illustrative reaction scheme for the synthesis of an ion exchange-functionalized PBI polymer molecule. In a first step, a chlorosulfonic acid linking agent reacts with the secondary amine of the benzimidazole unit to form a pendant sulfonic acid group as an intermediate linker. In a second step, the sulfonic acid group is converted into a tetravalent boron group using BF₃ (in the form of BF₃ etherate (Et₂O)), thus producing an ion exchange-functionalized PBI polymer molecule having a tetravalent boron group linked to the benzimidazole unit by way of a sulfonic ester linker. The boron atom of the tetravalent boron group has a negative formal charge and thus the ion exchange group is intrinsically ionic, thereby enabling ion (e.g., proton or other cation) exchange. While FIG. 11 shows the use of chlorosulfonic acid, in alternative examples other sulfonic acids having a leaving group may be used, such as bromosulfonic acid, iodosulfonic acid, etc.

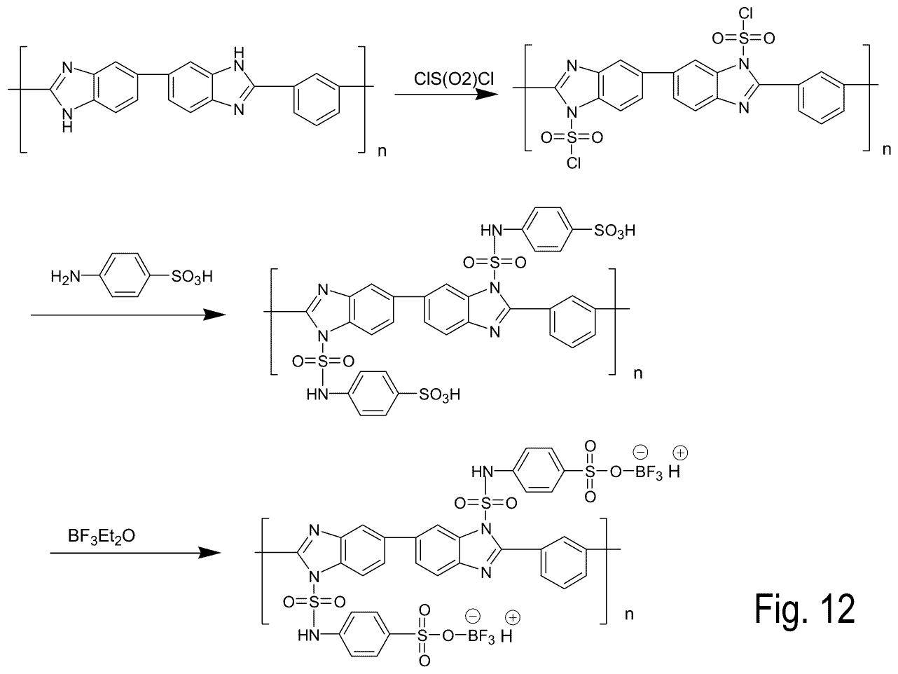

FIG. 12 shows another illustrative reaction scheme for the synthesis of an ion exchange-functionalized PBI polymer molecule. In the example of FIG. 12, an intermediate linker having a pendant acid group is formed in two steps, and the ion exchange group is produced in a third step. In the first step, a first linking agent (e.g., sulfuryl chloride) reacts, by way of the sulfur atom, with the secondary amine of the benzimidazole unit to form a first intermediate linker (N-sulfonyl chloride) having a pendant leaving group. However, other sulfuryl compounds having two leaving groups may be used. In the second step, a second linking agent having a pendant or terminal amino group and a pendant or terminal sulfonic acid group (e.g., aminobenzene sulfonic acid (sulfanilic acid)) reacts, by way of the amino group, with the sulfur atom of the first intermediate linker in a substitution reaction, thus resulting in a second intermediate linker having a pendant sulfonic acid group. However, the second linking agent may be any other aminoaryl sulfonic acid compound or derivative thereof, including compounds having multiple sulfonic acid groups in the aryl ring(s). In the third step, the sulfonic acid group is converted into a tetravalent boron group using BF₃ (in the form of BF₃ etherate (Et₂O)), thus producing an ion exchange-functionalized PBI polymer molecule having a tetravalent boron group linked to the benzimidazole unit by way of a sulfonic ester linker and a sulfuryl linker. The boron atom of the tetravalent boron group has a negative formal charge and thus the ion exchange group is intrinsically ionic, thereby enabling ion (e.g., proton or other cation) exchange.

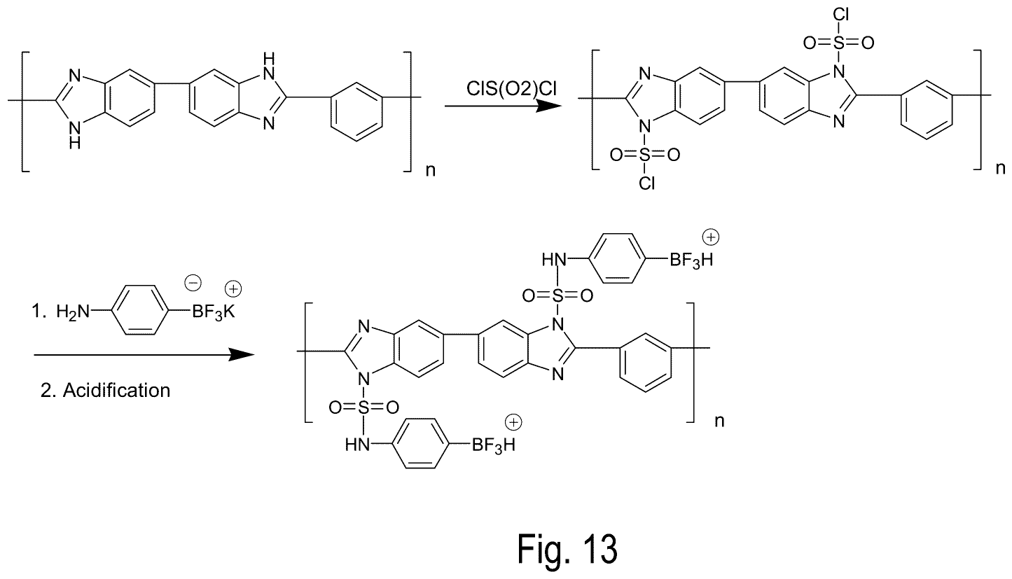

FIG. 13 shows another illustrative reaction scheme for the synthesis of an ion exchange-functionalized PBI polymer molecule. In a first step, a first linking agent (sulfuryl chloride) reacts, by way of the sulfur atom, with the secondary amine of the benzimidazole unit to form an intermediate linker (N-sulfonyl chloride) having a pendant leaving group. However, other sulfuryl compounds having two leaving groups may be used. In a second step, an ion exchange agent (a potassium salt of aminoaryl trifluoroborate) reacts directly with the first intermediate linker. However, any other suitable ion exchange group may be used. The amino group of the ion exchange group reacts with the intermediate linker (N-sulfonyl chloride) by a sulfur-nitrogen (S—N) bond to form an ion exchange group (the tetravalent boron group) linked with the benzimidazole unit by way of a sulfuryl linker. Optionally, the potassium cation is replaced by a proton in an acidification step.

In other examples, the reaction schemes of Examples 1-4B and 11-13 may be modified by using metal fluorides (e.g., MF₃ or MF₄) as the ion exchange agent instead of boron trifluoride or a trivalent boron compound. The metal fluorides may be any metal fluorides described above.

In some aspects, a first polymer molecule may be crosslinked with a second polymer molecule using a tetravalent boron crosslink to form a crosslinked polymer composition. The first polymer molecule may be any PBI polymer molecule, including any PBI polymer molecule described herein. In some examples, the second polymer molecule is a second PBI polymer molecule, which may be the same or different as the first PBI polymer molecule. In further examples, the second polymer molecule is a polymer molecule functionalized with an acid group (e.g., a sulfonic acid group, a carboxylic acid group, a phosphoric acid group, a phosphonic acid group) or a hydroxyl group. Examples of acid-functionalized and hydroxyl-functionalized polymer molecules include, without imitation, functionalized poly(tetrafluoroethylene) (PTFE) molecules, poly(phosphoric acid) (PPA) molecules, cellulose, lignin, etc.

The tetravalent boron crosslink has the general formula —BX₂—where each X is the different or the same and is independently a hydroxyl group or a halogen, such as fluorine or chlorine. The boron atom is covalently bonded to a secondary amine of the first PBI polymer molecule and to a secondary amine, an acid group, or a hydroxyl group of the second polymer molecule. With this configuration, the boron atom is tetravalent and has a formal negative charge, thus making the tetravalent boron crosslink intrinsically ionic and acid. The tetravalent boron crosslink may thus also function as an ion (e.g., cation) exchange group.

In some examples, a method of crosslinking a PBI polymer molecule and a second polymer molecule includes combining the first PBI polymer molecule, the second polymer molecule, and a crosslinking agent comprising a trivalent boron compound.

Any suitable crosslinking agent may be used that produces a tetravalent boron crosslink. In some examples, the crosslinking agent is boric acid, which has the general formula B(OH)₃, or a boronic acid, which has the general formula R—B(OH)₂, or a derivative of a boronic acid. Illustrative examples of a crosslinking agent include, without limitation, trimethyl borate, triethyl borate, tributyl borate, n-octyl borate, tridecyl borate, tritetradecyl borate, triisopropyl borate, tris(hexafluoroisopropyl) borate, trimethoxycyclotriboroxane, triphenyl borate, tri-o-tolyl borate, tris(trimethylsilyl) borate, tetraacetyl diborate, tris(2,2,2-trifluoroethyl) borate, bis-pinacol diboronate, pinacol boronate, allylboronic acid pinacol ester, and diisopropoxymethylborane. The boron atom of the crosslinking agent covalently bonds with the secondary amine of the first PBI polymer molecule and with a secondary amine, an acid group, or a hydroxyl group of the second polymer molecule. Specifically, the boron atom expands its valence to covalently bond with a nitrogen of the secondary amine of the first PBI polymer molecule. The boron atom also reacts with the nitrogen atom of the secondary amine, acid group, or hydroxyl group of the second polymer molecule through a substitution reaction.

In some examples, a fluoride treatment may be performed after crosslinking to substitute fluoro groups for the hydroxyl groups.

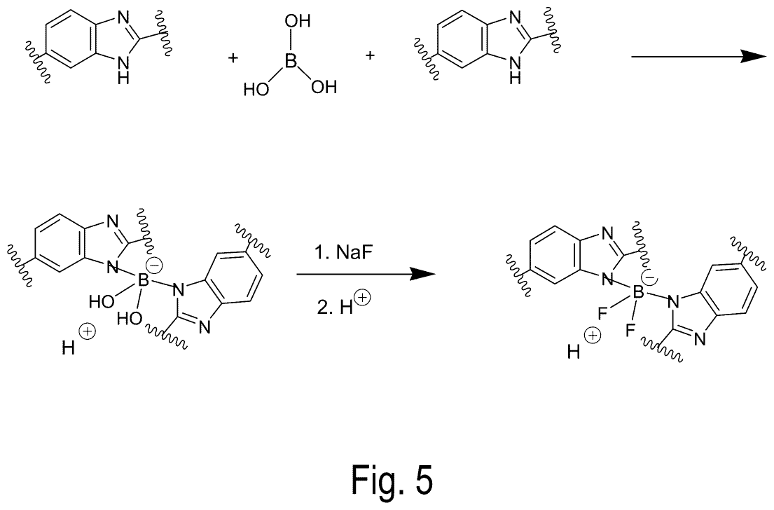

Illustrative examples of crosslinked PBI polymer molecules, and reaction schemes for crosslinking PBI polymer molecules with another polymer molecule, will now be shown and described with reference to FIGS. 5-7. The following examples are merely illustrative and are not limiting. In the drawings, only a benzimidazole unit of the repeating unit of the PBI polymer molecules is shown, but the repeating unit may have any other units and structure as may serve a particular implementation.

FIG. 5 shows an illustrative reaction scheme for intramolecular crosslinking of two PBI polymer molecules using boric acid (B(OH)₃) as the crosslinking agent. The reaction scheme of FIG. 5 may be carried out to crosslink PBI polymer layers or sheets. In a first step, PBI polymer molecules are combined with boric acid. Boric acid reacts with the secondary amines of the PBI polymer molecules to form a tetravalent boron crosslink having the general formula —B(OH)₂—. The boron atom has four covalent bonds and thus gains a negative formal charge, thereby making the tetravalent boron crosslink intrinsically ionic and acidic and capable of functioning as an ion (e.g., cation) transport agent. In some examples, boric acid is a limiting reagent to control the extent of crosslinking as well as the proton exchange capacity of the resulting ion exchange-functionalized PBI polymer composition.

In an optional second step, the acidity of the tetravalent boron crosslink is increased by a fluoride treatment. The fluoride treatment may be performed in any suitable way, such as by combining the crosslinked PBI polymer molecules with sodium fluoride (NaF).

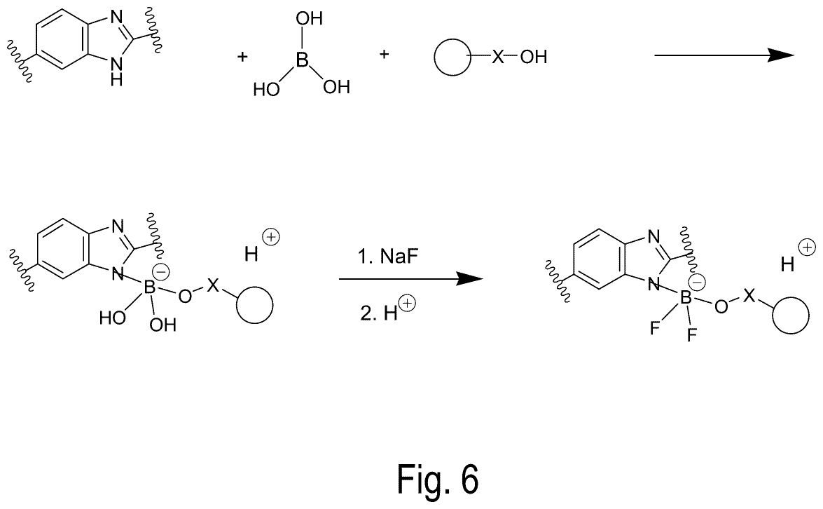

FIG. 6 shows an illustrative reaction scheme for intramolecular crosslinking of a PBI polymer molecule with a hydroxy-functionalized PTFE polymer using boric acid as the crosslinking agent. As shown, PTFE (represented by the open circle) is functionalized with an acid group represented by X-OH in which X is a substituent group containing a sulfur (S) atom, a carbon (C) atom, or a phosphorous (P) atom covalently bonded to the oxygen (O) atom of the hydroxyl group. The acid group X-OH may be any suitable acid group such as, without limitation, a carboxylic acid group, a sulfonic acid group, a phosphoric acid group, a phosphonic acid group, or an alcohol. In some examples, substituent group X includes a C₁ to C₃₀ alkyl linker chain and optionally has one or more pendant moieties, which may be the same or different and may each be independently selected from the group consisting of hydrogen, a hydroxyl group, a fluoro group, a chloro group, a dialkylamino group, a cyano group, a carboxylic acid group, a carboxylic amide group, an ester group, an alkyl group, an alkoxy group, and an aryl group. In some examples, the substituent group X may be omitted so that PTFE is functionalized with only the hydroxyl group. While FIG. 6 shows that PTFE is functionalized with only one acid group X-OH, PTFE may have any degree of functionalization as may serve a particular implementation.

In a first step, the PBI polymer molecule and the acid-functionalized PTFE polymer molecule are combined with boric acid. Boric acid reacts with the secondary amine of the first PBI polymer molecule and with the hydroxy group of the functionalized PTFE to form a tetravalent boron crosslink having the general formula —B(OH)₂—. The boron atom has four covalent bonds and thus gains a negative formal charge, thereby making the tetravalent boron crosslink intrinsically ionic and acidic and capable of functioning as an ion (e.g., cation) transport agent. In some examples, boric acid is a limiting reagent to control the extent of crosslinking as well as the proton exchange capacity of the resulting ion exchange-functionalized PBI/PTFE polymer composition.

In an optional second step, the acidity of the tetravalent boron crosslink is increased by a fluoride treatment, such as by combining the crosslinked PBI/PTFE polymer molecules with sodium fluoride (NaF).

While FIG. 6 shows that a PBI polymer molecule is crosslinked with a functionalized PTFE polymer molecule, the PBI polymer molecule may be crosslinked in a similar manner with any other suitable acid or hydroxy-functionalized polymer, such as a synthetic polymer (e.g., poly (phosphoric acid) (PPA)) or a natural polymer (e.g., lignin, cellulose, chitin, etc.). For example, a PBI polymer may be crosslinked with a PPA-doped polymer. The crosslinked PBI polymer prevents or reduces leaching out of the PPA dopant from the PPA-doped polymer.

In the examples of FIGS. 5 and 6, two polymer molecules are crosslinked using boric acid. In modifications of these reaction schemes, two polymer molecules may be crosslinked using a boric acid derivative, such as a boronic acid (e.g., (R—B(OH)₂ or (R¹—B(OH)—R²) or a trivalent boron having the general formula BXYZ, as described above with respect to FIG. 4B.

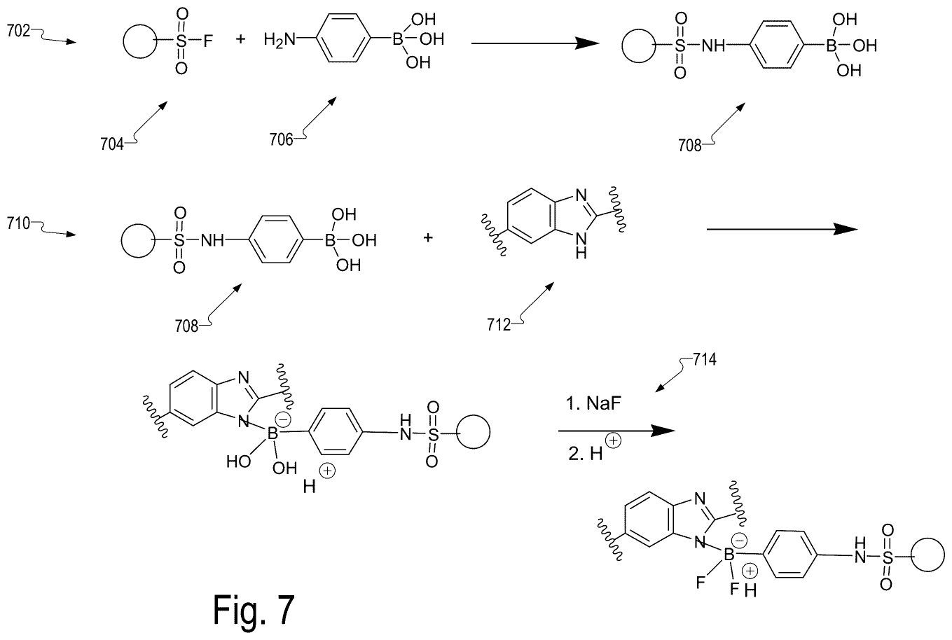

FIG. 7 shows an illustrative reaction scheme for crosslinking a PBI polymer molecule with a functionalized PTFE polymer molecule using an aminoboronic acid as the crosslinking agent.

In a first step 702, sulfonyl fluoride-functionalized PTFE 704 (the PTFE backbone is represented by an open circle) is combined with 4-aminophenylboronic acid 706. Sulfonyl fluoride-functionalized PTFE 704 forms a strong covalent bond with aminoboronic acid to form an intermediate aminoboronic acid-functionalized PTFE polymer molecule 708. A non-aqueous base may optionally be added to capture hydrogen fluoride (HF), thus helping to shift the reaction equilibrium to the right (to the product). It will be recognized that any other suitable aminoboronic acid or derivative thereof may be used, including, without limitation, aminophenyl, aminoaryl, and aminoalkyl boronic acids or boronic acid surrogates, such as boronic acid pinacolates.

In a second step 710, aminoboronic acid-functionalized PTFE polymer molecule 708 is combined with a PBI polymer molecule 712. The boric acid group of aminoboronic acid-functionalized PTFE polymer molecule 708 reacts with the secondary amine of PBI polymer molecule 712, thereby crosslinking PBI polymer molecule 708 with functionalized PTFE polymer molecule 704. The boron atom of the tetravalent boron crosslink has four covalent bonds and thus gains a negative formal charge, thereby making the tetravalent boron crosslink intrinsically ionic and acidic and capable of functioning as an ion (e.g., cation) transport agent.

In an optional third step 714, the acidity of the tetravalent boron crosslink may be increased by a fluoride treatment, such as by combining the crosslinked polymer molecules with sodium fluoride (NaF).

While FIG. 7 shows that PBI polymer molecule 712 is crosslinked with functionalized PTFE polymer molecule 704, PBI polymer molecule 712 may be crosslinked in a similar manner with any other suitable activated polymer molecule, including, without limitation, synthetic or natural polymer molecules.

As shown in FIG. 7, the reaction scheme begins with sulfonyl fluoride-functionalized PTFE polymer molecule 704. In other examples (not shown), the reaction scheme may begin with a sulfonic acid-functionalized PTFE polymer molecule (or other polymer molecule). However, since a sulfonic acid group generally does not directly covalently bond with the primary amine of an aminoboronic acid, the sulfonic acid group is activated to a sulfonyl fluoride group (SO₂F) for reaction with the primary amine of the aminoboronic acid. Alternatively, the sulfonic acid group may be activated to a sulfonyl chloride group (SO₂Cl) for reaction with the primary amine of the aminoboronic acid.

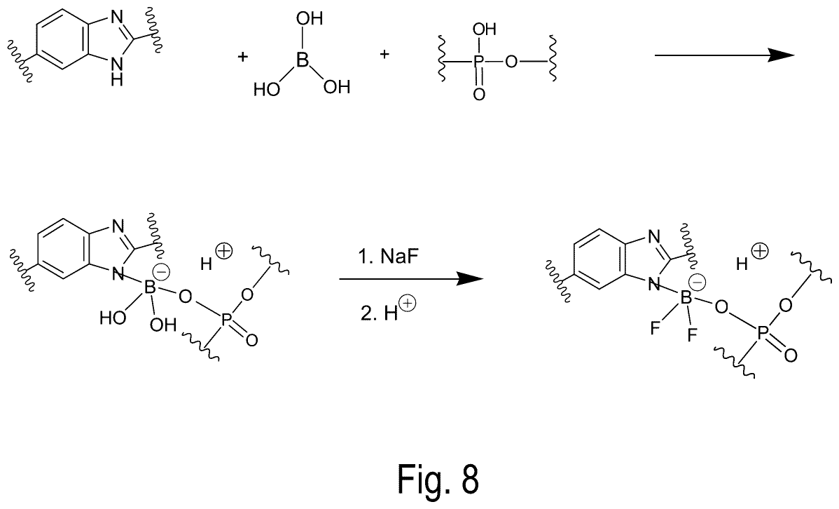

FIG. 8 shows an illustrative reaction scheme for intramolecular crosslinking of a PBI polymer molecule with a PPA polymer molecule using boric acid as the crosslinking agent. PPA has the general structure shown below as Formula (V):

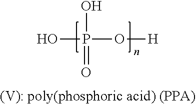

In some examples, PPA is used as a dopant to improve cation conductivity of PBI polymers, such as 4F-PBI. However, the direct linking of PPA with PBI happens through weak, equilibrating acid-base interactions only between the acidic phosphates of PPA and basic imidazole nitrogen atoms of PBI. As a result, acidic phosphate residues leach out of the PEMs and ionomers, thus degrading the cation exchange performance of the PBI polymer. To improve PBI/PPA polymer performance, a PBI polymer may be crosslinked with a PPA polymer using a tetravalent boron crosslink, as shown in the example of FIG. 8. Note that, in the example of FIG. 8, only a repeating unit of a PPA polymer molecule is shown. However, the degree of crosslinking may be controlled as desired.

As shown in FIG. 8, in a first step the PBI polymer molecule and the PPA polymer molecule are combined with boric acid. Boric acid reacts with the secondary amine of the PBI polymer molecule and with the hydroxyl group of the PPA polymer molecule to form a tetravalent boron crosslink having the general formula —B(OH)₂—. The boron atom bonds with the nitrogen of the secondary amine and the oxygen atom of the PPA molecule in addition to the two hydroxyl groups. Thus, the boron atom has four covalent bonds and gains a negative formal charge. As a result, the tetravalent boron crosslink is intrinsically ionic and acidic and capable of functioning as an ion (e.g., cation) transport agent. Moreover, crosslinking through the tetravalent boron atom occurs through multiple boron-oxygen bonds, thus strongly binding PPA and adding robustness and minimizing leaching of PPA. In some examples, boric acid is a limiting reagent to control the extent of crosslinking as well as the proton exchange capacity of the resulting ion exchange-functionalized PBI/PPA composition.

In an optional second step, the acidity of the tetravalent boron crosslink is increased by a fluoride treatment, such as by combining the crosslinked PBI/PPA polymer molecules with sodium fluoride (NaF).

In the example of FIG. 8, PBI and PPA polymer molecules are crosslinked using boric acid. In a modification of this reaction scheme, PBI and PPA polymer molecules may be crosslinked using a boric acid derivative, such as a boronic acid (e.g., (R—B(OH)₂ or (R¹—B(OH)—R²) or a trivalent boron having the general formula BXYZ, as described above with respect to FIG. 4B.

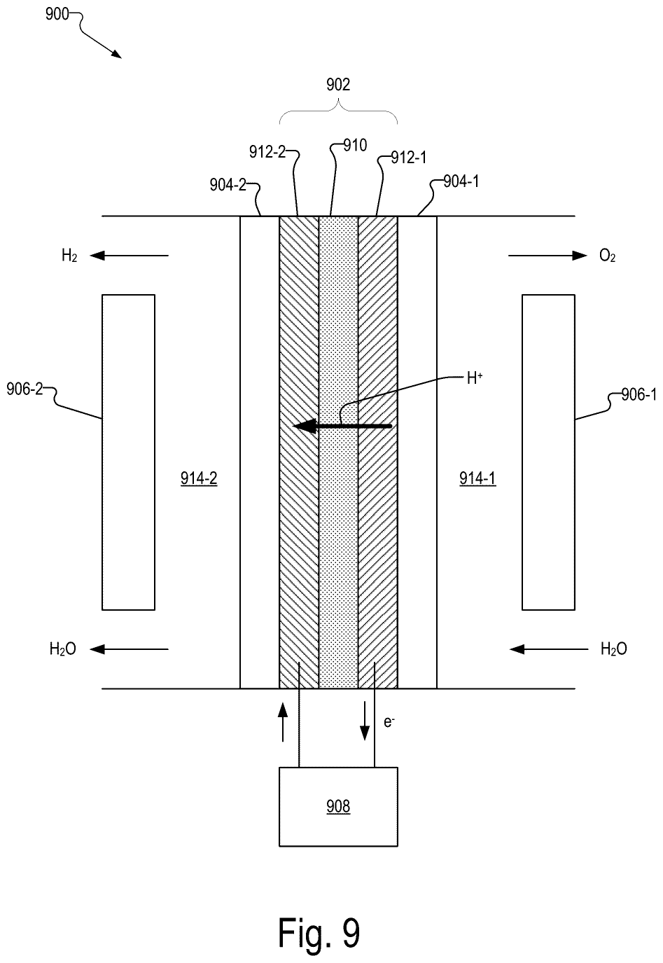

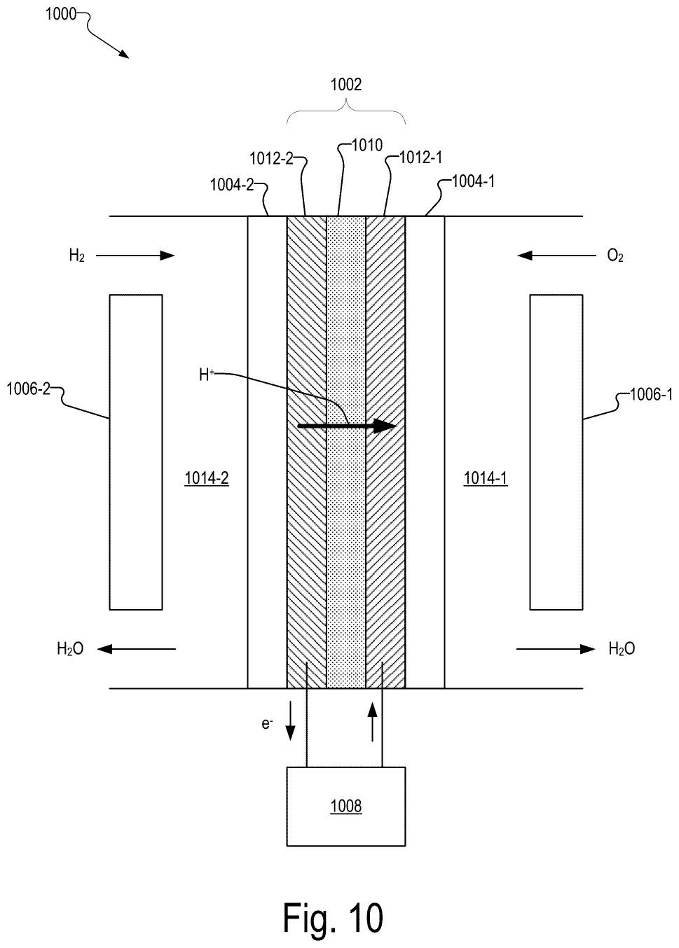

The ion exchange-functionalized PBI polymers and polymer compositions described herein, including the tetravalent boron-crosslinked polymer compositions, may be formed as a porous polymer network and/or may be used as ionomers, membranes, and/or PEMs. The polymers, ionomers, and membranes (e.g., PEMs) described herein may be used in water electrolysis systems and fuel cells, as well as in batteries (e.g., as separation membranes) and in the production of ammonia (e.g., for the production of H₂ as a precursor to the Haber-Bosch process and/or for the generation of electricity used for separation of nitrogen gas from air and/or during the Haber-Bosch process). Illustrative applications for ion exchange-functionalized PBI polymers described will now be described with reference to FIGS. 9 and 10.

FIG. 9 shows an illustrative proton exchange membrane water electrolysis system 900 (PEM water electrolysis system 900). PEM water electrolysis system 900 uses electricity to split water into oxygen (O₂) and hydrogen (H₂) via an electrochemical reaction. The configuration of PEM water electrolysis system 900 is merely illustrative and not limiting, as other suitable configurations as well as other suitable water electrolysis systems may incorporate a boron-containing porous membrane.

As shown in FIG. 9, PEM water electrolysis system 900 includes a membrane electrode assembly 902 (MEA 902), porous transport layers 904-1 and 904-2, bipolar plates 906-1 and 906-2, and an electrical power supply 908. PEM water electrolysis system 900 may also include additional or alternative components not shown in FIG. 9 as may serve a particular implementation.

MEA 902 includes a PEM 910 positioned between a first catalyst layer 912-1 and a second catalyst layer 912-2. PEM 910 electrically isolates first catalyst layer 912-1 from second catalyst layer 912-2 while providing selective conductivity of cations, such as protons (H⁺), and while being impermeable to gases such as hydrogen and oxygen. PEM 910 may be implemented by any suitable PEM, including any PEM described herein. For example, PEM 910 may be implemented by an ion exchange-functionalized PBI polymer described herein.

First catalyst layer 912-1 and second catalyst layer 912-2 are electrically conductive electrodes with embedded electrochemical catalysts (not shown), such as platinum, ruthenium, and/or or cerium (IV) oxide. In some examples, first catalyst layer 912-1 and second catalyst layer 912-2 are formed using an ionomer to bind catalyst nanoparticles. The ionomer used to form first catalyst layer 912-1 and second catalyst layer 912-2 may include an ion exchange-functionalized PBI polymer as described herein.

MEA 902 is placed between porous transport layers 904-1 and 904-2, which are in turn placed between bipolar plates 906-1 and 906-2 with flow channels 914-1 and 914-2 located in between bipolar plates 906 and porous transport layers 904.

In MEA 902, first catalyst layer 912-1 functions as an anode and second catalyst layer 912-2 functions as a cathode. When PEM water electrolysis system 900 is powered by power supply 908, an oxygen evolution reaction (OER) occurs at anode 912-1, represented by the following electrochemical half-reaction:

2 H₂O→O₂+4 H⁺+4e⁻

Protons are conducted from anode 912-1 to cathode 912-2 through PEM 910, and electrons are conducted from anode 912-1 to cathode 912-2 by conductive path around PEM 910. PEM 910 allows for the transport of protons (H⁺) and water from the anode 912-1 to the cathode 912-2 but is impermeable to oxygen and hydrogen. At cathode 912-2, the protons combine with the electrons in a hydrogen evolution reaction (HER), represented by the following electrochemical half-reaction:

4 H⁺+4 e⁻→2 H₂

The OER and HER are two complementary electrochemical reactions for splitting water by electrolysis, represented by the following overall water electrolysis reaction:

2 H₂O→2 H₂+O₂

FIG. 10 shows an illustrative proton exchange membrane fuel cell 1000 (PEM fuel cell 1000) including a boron-containing porous membrane. PEM fuel cell 1000 produces electricity as a result of electrochemical reactions. In this example, the electrochemical reactions involve reacting hydrogen gas (H₂) and oxygen gas (O₂) to produce water and electricity. The configuration of PEM fuel cell 1000 is merely illustrative and not limiting, as other suitable configurations as well as other suitable proton exchange membrane fuel cells may incorporate a boron-containing porous membrane.

As shown in FIG. 10, PEM fuel cell 1000 includes a membrane electrode assembly 1002 (MEA 1002), porous transport layers 1004-1 and 1004-2, bipolar plates 1006-1 and 1006-2. An electrical load 1008 may be electrically connected to MEA 1002 and driven by PEM fuel cell 1000. PEM fuel cell 1000 may also include additional or alternative components not shown in FIG. 10 as may serve a particular implementation.

MEA 1002 includes a PEM 1010 positioned between a first catalyst layer 1012-1 and a second catalyst layer 1012-2. PEM 1010 electrically isolates first catalyst layer 1012-1 from second catalyst layer 1012-2 while providing selective conductivity of cations, such as protons (H⁺), and while being impermeable to gases such as hydrogen and oxygen. PEM 1010 may be implemented by any suitable PEM, including any PEM described herein. For example, PEM 1010 may be implemented by an ion exchange-functionalized PBI polymer described herein.

First catalyst layer 1012-1 and second catalyst layer 1012-2 are electrically conductive electrodes with embedded electrochemical catalysts (not shown). In some examples, first catalyst layer 1012-1 and second catalyst layer 1012-2 are formed using an ionomer to bind catalyst nanoparticles. In some examples, the ionomer used to form first catalyst layer 1012-1 and second catalyst layer 1004-2 comprising an ion exchange-functionalized PBI polymer as described herein.

MEA 1002 is placed between porous transport layers 1004-1 and 1004-2, which are in turn placed between bipolar plates 1006-1 and 1006-2 with flow channels 1014 located in between. In MEA 1002, first catalyst layer 1012-1 functions as a cathode and second catalyst layer 1012-2 functions as an anode. Cathode 1012-1 and anode 1012-2 are electrically connected to load 1008, and electricity generated by PEM fuel cell 1000 drives load 1008.

During operation of PEM fuel cell 1000, hydrogen gas (H₂) flows into the anode side of PEM fuel cell 1000 and oxygen gas (O₂) flows into the cathode side of PEM fuel cell 1000. At anode 1012-2, hydrogen molecules are catalytically split into protons (H⁺) and electrons (e⁻) according to the following hydrogen oxidation reaction (HOR):

2H₂→4 H⁺+4 e⁻

The protons are conducted from anode 1012-2 to cathode 1012-1 through PEM 1010, and the electrons are conducted from anode 1012-2 to cathode 1012-1 around PEM 1010 through a conductive path and load 1008. At cathode 1012-1, the protons and electrons combine with the oxygen gas according to the following oxygen reduction reaction (ORR):

O₂+4 H⁺+4 e⁻→2 H₂O

Thus, the overall electrochemical reaction for the PEM fuel cell 1000 is:

2 H₂+O₂→2 H₂O

In the overall reaction, PEM fuel cell 1000 produces water at cathode 1012-1. Water may flow from cathode 1012-1 to anode 1012-2 through PEM 1010 and may be removed through outlets at the cathode side and/or anode side of PEM fuel cell 1000. The overall reaction generates electrons at the anode that drive load 1008.

In the preceding description, various exemplary embodiments have been described with reference to the accompanying drawings. It will, however, be evident that various modifications and changes may be made thereto, and additional embodiments may be implemented, without departing from the scope of the claims that follow. For example, certain features of one embodiment described herein may be combined with or substituted for features of another embodiment described herein. The description and drawings are accordingly to be regarded in an illustrative rather than a restrictive sense.

What is claimed is:

1. An ion exchange-functionalized polymer molecule comprising:
a repeating unit comprising a benzimidazole unit as at least part of a main chain, a side chain, or both; and
an ion exchange group linked to the repeating unit, wherein the ion exchange group comprises a tetravalent boron group or a metal fluoride, the metal fluoride comprising a multivalent metal atom.

2. The ion exchange-functionalized polymer molecule of claim 1, wherein repetition of the repeating unit constitutes 4F-PBI.

3. The ion exchange-functionalized polymer molecule of claim 1, wherein the ion exchange group comprises the tetravalent boron group.

4. The ion exchange-functionalized polymer molecule of claim 3, wherein the tetravalent boron group comprises a boron trifluoride group.

5. The ion exchange-functionalized polymer molecule of claim 3, wherein the tetravalent boron group has the general formula —BX₃, wherein each X independently comprises an alkyl group, an alkoxy group, an alkyloxycarbonyl group, an aryl group, an aryloxy group, a hydroxyl group, a fluoro group, a cyano group, or a pentafluorophenyl group.

6. The ion exchange-functionalized polymer molecule of claim 1, wherein the ion exchange group comprises the metal fluoride.

7. The ion exchange-functionalized polymer molecule of claim 1, wherein:
a boron atom of the tetravalent boron group or the multivalent metal atom is covalently bonded to a nitrogen atom of a secondary amine of the benzimidazole unit.

8. The ion exchange-functionalized polymer molecule of claim 1, wherein the ion exchange group is linked to a phenyl unit of the repeating unit.

9. The ion exchange-functionalized polymer molecule of claim 1, wherein the ion exchange group is linked to a secondary amine of the benzimidazole unit by way of a linker.

10. The ion exchange-functionalized polymer molecule of claim 9, wherein the linker comprises an alkyl chain having two to ten atoms in a backbone of the alkyl chain.

11. The ion exchange-functionalized polymer molecule of claim 9, wherein the linker comprises a sulfonic ester linker or sulfuryl linker.

12. A method of making an ion exchange-functionalized polymer molecule, comprising:
linking an ion exchange agent with a repeating unit of a polymer molecule, wherein:
the polymer molecule comprises a benzimidazole unit as at least part of a main chain or a side chain of the polymer molecule; and
the ion exchange agent comprises a trivalent boron compound or a metal fluoride, the metal fluoride comprising a multivalent metal atom.

13. The method of claim 12, wherein the polymer molecule comprises a polybenzimidazole (PBI) polymer molecule.

14. The method of claim 12, wherein the ion exchange agent comprises the trivalent boron compound and linking the ion exchange agent with the repeating unit comprises covalently bonding a boron atom of the trivalent boron compound with a nitrogen atom of a secondary amine of the benzimidazole unit.

15. The method of claim 12, wherein the ion exchange agent comprises the metal fluoride and linking the ion exchange agent with the repeating unit comprises covalently bonding the multivalent metal atom of the metal fluoride with a nitrogen atom of a secondary amine of the benzimidazole unit.

16. The method of claim 12, wherein linking the ion exchange agent with the repeating unit comprises:
forming an intermediate linker connected to a secondary amine of the benzimidazole unit, wherein the intermediate linker includes a pendant acid group or a pendant hydroxyl group; and
reacting the ion exchange agent with the pendant acid group or the pendant hydroxyl group.

17. The method of claim 16, wherein the pendant acid group comprises a sulfonic acid group.

18. The method of claim 16, wherein forming the intermediate linker comprises bonding a linking agent with the secondary amine, wherein the linking agent comprises a sulfonated compound or a sulfuryl compound.

19. The method of claim 12, wherein linking the ion exchange agent with the repeating unit comprises:
forming an intermediate linker comprising a pendant sulfonic acid group linked to a phenyl unit of the repeating unit; and
reacting the ion exchange agent with the pendant sulfonic acid group of the intermediate linker.

20. A polybenzimidazole (PBI) polymer comprising:
a main chain comprising benzimidazole units; and
ion exchange groups linked to the benzimidazole units;
wherein the ion exchange groups comprise tetravalent boron groups or metal fluoride groups, each metal fluoride group comprising a multivalent metal atom, and
wherein the ion exchange groups are linked to secondary amines of the benzimidazole units.
